(19) United States
(12) Patent Application Publication
(10) Pub. No.: US 2025/0026592 A1
(43) Pub. Date: Jan. 23, 2025

(54) CONTROLLED ENVIRONMENT WITH A TRANSPORT DEVICE, USE OF CLAMPING DEVICES, USE OF AT LEAST ONE SEALING ELEMENT, USE OF A TRANSPORT UNIT

(71) Applicant: TT Innovation AG, Zug (CH)

(72) Inventors: Mathieu Muller, Sierentz (FR); Mike ZELLER, Wahlen (CH); Christoph Joschi GEISER, Bottmingen (CH)

(73) Assignee: TT Innovation AG, Zug (CH)

(21) Appl. No.: 18/909,043

(22) Filed: Oct. 8, 2024

Related U.S. Application Data
(63) Continuation-in-part of application No. 18/008,735, filed on Dec. 22, 2022, now Pat. No. 12,116,214.

(30) Foreign Application Priority Data
Jun. 18, 2021 (EP) 21180412.5

(51) Int. Cl. B65G 54/02; F24F 3/167

(52) U.S. Cl. CPC B65G 54/02; F24F 3/167; B65G 2207/26

(57) ABSTRACT

For a controlled environment (1), adjacent drive modules (5) of a transport device (4) of the controlled environment (1) are sealed against each other in a sealing region (12) such that particles and/or impurities, in particular microbiological impurities, do not enter the controlled environment (1) from the outside. Each drive module (5) is designed for levitation (6) of at least one transport unit (7), in particular a mover (8), and a coupling side (9) of the drive module (5) is very substantially covered by a sealing member (10).

### CROSS-REFERENCE TO RELATED APPLICATIONS

This application is a continuation-in-part of U.S. patent application Ser. No. 18/008,735, filed Dec. 22, 2022, which is a 371 National Phase of PCT/EP2022/066602, filed Jun. 17, 2022, which claims priority from European Patent Application No. 21180412.5, filed Jun. 18, 2021, all of which are incorporated herein by reference as if fully set forth.

### TECHNICAL FIELD

The invention relates to a controlled environment, in particular containment or isolator, with a transport device, which has at least two drive modules in an arrangement, each drive module being designed for magnetic levitation of at least one transport unit.

The invention further relates to the use of clamping means for the force-fitting and/or form-fitting connection of the drive modules, in particular wherein the sealing region is compressed.

The invention furthermore relates to the use of at least one sealing element in a sealing region.

Finally, the invention relates to the use of a transport unit.

### BACKGROUND

Controlled environments with a transport device on which a transport unit can be movable are known from practice. Furthermore, levitatable transport units are known from practice and are used, for example, to move and/or hold a payload in a magnetically controlled manner by a coil field and/or by a permanent-magnetic arrangement, which can be arranged in a drive surface.

### SUMMARY

The invention is based on the object of reducing the risk of contamination of the controlled environment by particles and/or impurities, in particular microbiological impurities, which can enter the controlled environment from the outside through gaps between adjacent drive modules, and of protecting a coil field and/or a permanent-magnetic arrangement of the drive surface from influences from the controlled environment, such as decontaminants (e.g. hydrogen peroxide (H₂O₂)) and/or cleaning agents.

To achieve the stated object, one or more of the features disclosed herein are provided according to the invention. In particular, to achieve said object in a controlled environment of the type described at the beginning, it is proposed according to the invention that each drive module is covered on a coupling side with a sealing member, and that adjacent drive modules seal against each other in a sealing region.

Any component of the controlled environment causing and/or contributing to the levitation and/or a movement of the transport unit, for example a mover, can be understood as a transport device. The transport device therefore also includes a drive surface. The drive surface is in turn characterized by the coupling side, via which a magnetic interaction or coupling between the transport unit and the transport device can be brought about via a levitation generator.

The concept of levitation can be characterizable here, for example, by the fact that, in a magnetic field which is formed in a controlled manner and is brought about by the levitation generator of the transport device, the transport unit, which is equipped with at least one permanent magnet or electromagnet or is magnetically active in some other way, hovers and/or is moved by controlled changing of the magnetic field.

In particular, every smallest, individually operable unit for generating the levitation can be understood as a drive module. Thus, the levitation generator consists of at least one drive module or a plurality of drive modules of the transport device. The levitation generator, and thus, for example, the at least one drive module, can be formed, for example, with means for generating a coil field and/or with a permanent-magnetic arrangement.

The sealing member may in turn be formed by an, in particular magnetically neutral, separating layer which, as described and claimed further on and in more detail, is at least partially placed onto and/or applied to at least one drive module. Magnetically neutral in the context of the invention can mean that a disturbance or impairment of the magnetic coupling between the transport device, in particular the coupling side, and the transport unit can be reduced or avoided by the materials used, in particular in such a way that control of the levitation is not disturbed in such a way that the levitation breaks off. Particularly advantageously, an undisturbed magnetic coupling via the coupling side can thus be realized.

Furthermore, the sealing member can form a separation between the drive modules and the controlled environment, as a result of which it can advantageously be achieved that the risk of contamination by particles and/or impurities, in particular microbiological impurities, can be reduced.

The sealing region in turn, in which the at least two adjacent drive modules seal against each other, advantageously additionally has the effect that no particles and/or impurities, in particular microbiological impurities, enter an intermediate region of the adjacent drive modules. Even if particles and/or impurities enter the intermediate region, the sealing region can prevent them from entering an interior of the controlled environment, in particular the containment or the isolator.

A controlled environment can be characterizable, for example, as a limited spatial region, in which defined environmental conditions, in particular with regard to air purity and/or surface purity, can be created and/or can be maintained, for example by control of an air exchange with a world outside the controlled environment. The control of the air exchange can be realized, for example, by a complete exclusion of the air exchange during normal operation (for example, except for a closed circulation of air) or a consequent stipulation of a direction of the air exchange (into the controlled environment or out of the controlled environment). Examples of controlled environments include isolators, restricted access barrier systems (especially of the open or closed type), containments, and gloveboxes.

Within the controlled environment, in particular the containment or the isolator, various processes for processing a very wide variety of products, for example pharmaceutical products, can be undertaken, with the risk of contamination of at least one product by particles and/or impurities from outside the controlled environment being able to be eliminated. Such pharmaceutical products may, for example, each have a pharmaceutical container for receiving a pharmaceutical preparation. A list of examples of such pharmaceutical containers includes at least vials, syringes, cartridges and other fillable pharmaceutical containers.

The concept of “sealing” can thus be understood, for example, as meaning fluidic sealing such that no fluids whatsoever, for example gas, in particular air, containing, for example, the particles and/or impurities, enter from the intermediate region of the adjacent drive modules through the sealing region into the controlled environment.

Another advantage for reducing contamination can be achieved by the sealing member covering the drive modules and thus also the sealing region such that double sealing capability can be achieved. Even if contaminants, for example from outside the controlled environment, enter through the sealing region, the sealing member can prevent them from entering the interior of the controlled environment.

In a further advantageous embodiment, it can be provided that the sealing region has at least one sealing element.

The sealing element can, for example, either completely or partially seal an intermediate region, for example, the intermediate region already mentioned, of the adjacent drive modules; in particular, however, the region which faces an interior of the controlled environment is advantageously sealed. Thus, particularly advantageously, in addition to the advantages already described, the reduction of the contamination risk of the controlled environment can be achieved in that the adjacent drive modules can be variously sealed in the sealing region by the wide range of different sealing elements.

In this connection, it can be provided, for example, that the sealing element contacts at least one drive module, preferably the two drive modules, such that the sealing region can be closed. Furthermore, it can be provided, for example, that the sealing element contacts at least one sealing member and/or at least one sealing member and a drive module.

In a further advantageous embodiment of the invention, it can be provided that the sealing region is formed from or with an H₂O₂-resistant material.

Hydrogen peroxide (H₂O₂) is an important component of the controlled environment described herein, since the controlled environment, in particular the containment or the isolator, is decontaminated via a decontamination cycle by means of hydrogen peroxide prior to the process or a process to be carried out within the controlled environment. For this purpose, hydrogen peroxide is passed through the controlled environment, as a result of which all of the particles and/or impurities, in particular microbiological impurities, within the controlled environment can be biologically deactivated. Since even the sealing region is decontaminated by means of hydrogen peroxide before the process or a process to be carried out within the controlled environment, it is important that the sealing region is formed from or at least with an H₂O₂-resistant material, so that it can be ensured that the material does not suffer any damage whatsoever during the decontamination cycle.

Advantageously, therefore, a long service life of the material of the sealing region over a multiplicity of decontamination cycles and thus a consistently good sealing capability of the adjacent drive modules in the sealing region can be achieved.

Alternatively or in addition, it can be provided that the sealing member is formed from or with an H₂O₂-resistant material.

Since the sealing member likewise has to be decontaminated via the decontamination cycle or a decontamination cycle before the process or a process to be carried out within the controlled environment in order to prevent—impurities, in particular microbiological impurities, contaminating the product or a product to be processed, it is particularly advantageous if the sealing member is resistant to the decontaminant used, here likewise hydrogen peroxide. Here, too, a long service life of the sealing member can thereby be advantageously achieved.

A multiplicity of products can be used for cleaning and decontaminating the controlled environment and combinations are also conceivable. For example, isolators are often treated in a plurality of steps and with different cleaning agents and/or decontaminants. For example, hydrogen peroxide (H₂O₂), isopropanol, ethylene oxide and other agents are used.

The sealing member and/or the sealing region may, for example, be made of a stainless steel and/or glass or comprise such a material. Alternatively or in addition, it can be provided that the sealing member and/or the sealing region is composed of a plastic, for example a rubber and/or a composite material. It can be used as a rigid or flexible, in particular film-like layer.

In general, it can also be provided that the sealing region and/or the sealing member are/is made of or formed from a material which is resistant to various other decontaminants.

In a further advantageous embodiment, it can be provided that the sealing member consists of a non-outgassing material, in particular a material which does not outgas H₂O₂.

“Non-outgassing” can be understood as meaning that a pore size of the material is selected such that, for example, either no gas, in particular hydrogen peroxide, can be absorbed at all or if a gas, in particular hydrogen peroxide, has nevertheless been absorbed by the material, it is not discharged again to the environment. Thus, it can advantageously be prevented that a gas absorbed by the material, in particular hydrogen peroxide, is discharged by the sealing member during the process or a process carried out within the controlled environment. The discharging of gases, in particular hydrogen peroxide, of the material during processing of the product or a product, in particular pharmaceutical product, may lead to contamination of the product and should accordingly be prevented.

Alternatively or in addition, it can be provided that the sealing region consists of a non-outgassing material, in particular a material which does not outgas H₂O₂.

It is thereby possible to achieve the advantages already described that can be achieved if the sealing member consists of a non-outgassing material, in particular a material which does not outgas H₂O₂.

It can be provided, for example, that the sealing element and the sealing region are formed from the same material.

In a further advantageous embodiment of the invention, it can be provided that the sealing region is formed integrally on the sealing member.

The sealing region can have, for example, the sealing element or a sealing element, for example, the sealing element already mentioned and claimed, which is connected integrally in particular to the sealing member. This can be achieved, for example, by connecting the sealing element to the sealing member in an integrally bonded manner. For example, the sealing member can be glued or welded to the sealing element. Further, it can be provided, for example, that the sealing region can be sealed by two sealing members connected integrally to each other. Alternatively or additionally, it can be provided that the sealing member and the material of the sealing region form a composite material.

Particularly advantageously, it can thus be achieved, for example, that there is thus no separate transition region between the sealing region and sealing member, via which contamination could take place.

In a further advantageous embodiment of the invention, it can be provided that the sealing region connects at least two sealing members, preferably in a mesh-like manner, to one another. A mesh-like connection can, for example, be characterizable in that the sealing region has at least one hole into which, for example, a drive module can be inserted. A mesh-like form of the seal can be produced in particular by the use of silicone for the sealing.

It can be provided, for example, that the sealing region has a sealing element, for example, the sealing element already mentioned, which in turn is connected, preferably in a form-fitting and/or force-fitting manner, on one side to the first sealing member, which covers, for example, a first of the two drive modules, and on another side to the second sealing member, which in particular covers a second of the two drive modules. Particularly advantageously, a direct transition between the sealing region and sealing member for improved sealing capability of the sealing region can thereby be achieved.

Furthermore, it can be provided, for example, that the two sealing members without a sealing element, for example the sealing element already mentioned, are connected to each other via the sealing region, for example, in a form-fitting and/or force-fitting manner. Particularly advantageously, an additional sealing element in the sealing region can be dispensed with here.

Preferably, the sealing region connects at least four or a multiplicity of sealing members to one another.

If, for example, more than two adjacent drive modules are formed, all of the further drive modules can therefore advantageously be sealed against each other in the sealing region.

In a further advantageous embodiment, the invention can provide that adjacent sealing members are separated from each other.

The concept of “separated” can be understood here, for example, as meaning that two adjacent sealing members are not directly in contact. Thus, for example, it can be achieved that the sealing members can be exchanged separately from each other if required. It can be provided, for example, that the sealing members are formed adjacent to the sealing element or a sealing element, for example, the sealing element already described and claimed, of the sealing region.

Here, for example, it can be provided that the sealing members do not touch the sealing region, as a result of which in turn the sealing element or a sealing element can likewise be exchanged independently of the sealing members.

Furthermore, it can be provided that the two sealing members, as already described and/or claimed, are connected to each other via the sealing region. Thus, a separating surface sealed hermetically and/or extensively and/or without gaps can be formed.

Alternatively or additionally, it can be provided that the sealing region is formed integrally with the sealing members. This enables the advantages already described to be realized. Thus, a transition from the sealing region to each sealing member can be simply formed gas-tightly.

In a further advantageous embodiment of the invention, it can be provided that the sealing region defines a sealing of the controlled environment to the outside.

“To the outside” can mean, for example, that a region outside the controlled environment is sealed off from a region inside the controlled environment by the sealing region.

The region outside the controlled environment, in particular the containment or the isolator, can be characterized, for example, by air quality which is differentiated from that from within the controlled environment. For example, the region within the controlled environment can be a high purity, sterile and/or decontaminated environment.

Particularly advantageously, it is thus possible to prevent particles and/or impurities, in particular microbiological impurities, from being able to enter the interior of the controlled environment from outside the controlled environment, and vice versa. This can also increase the process reliability.

In a further advantageous embodiment of the invention, it can be provided that at least one drive module of the arrangement forms a tight connection to a boundary wall of the controlled environment.

For example, the boundary wall can define a tight boundary from the exterior of the controlled environment to the interior of the controlled environment. The boundary wall can be arranged in particular horizontally and/or vertically and/or obliquely. Owing to the fact that the drive module of the arrangement forms a tight connection to the boundary wall of the controlled environment, a particularly space-saving variant of the transport device can be realized.

It can be provided, for example, that the boundary wall is itself formed from the separating layer or a separating layer, for example, the in particular magnetically neutral separating layer already mentioned, which in turn can be a component of the sealing member or contacts the latter.

If the sealing region has, for example, the sealing element or a sealing element, for example, the sealing element already described and claimed, it can be provided in this case, for example, that the sealing element contacts the at least one drive module and the boundary wall. Furthermore, it can be provided, for example, that the sealing element contacts at least one sealing member, the drive module and the boundary wall.

The drive surface can generally be arranged horizontally, vertically and/or obliquely. The sealing member regions and/or sealing regions, for example, the sealing elements, provided thereabove and/or thereon also correspond.

In a further advantageous embodiment, the invention can provide that the sealing member covers the coupling side of at least one drive module at least by up to 60%, preferably completely.

Particularly advantageously, as great a covering of the drive module as possible can thus be achieved.

In a further advantageous embodiment of the invention, it can be provided that the sealing member is flat or linear.

It can be provided, for example, if the sealing member is flat, that a large part of the drive module can be covered with just one member. This can be realized, for example, in a particularly simple and efficient manner by means of a film which is applied to and/or placed onto the drive module in a force-fitting and/or form-fitting manner. The sealing member can also be flat and designed so as to extend around an edge.

If the sealing member is linear, this can mean that a longitudinal extent of the sealing member is smaller than an extent transverse to the longitudinal extent. Particularly advantageously, a lower material consumption can thus be achieved by, for example, individual or a plurality of linear sealing members next to one another being applied to and/or placed onto the drive module. Thus, for example, even more complex shapes, for example crosses, can be formed and/or remaining columns can be sealed.

Alternatively or in addition, it can be provided that the sealing region is flat or linear.

A flat sealing region can be understood as meaning, for example, that the intermediate region or an intermediate region of the adjacent drive modules is/are sealed by a flat element, for example the sealing element or a sealing element, in particular the sealing element already mentioned and claimed. Particularly advantageously, the sealing region can thus be defined over a larger area, as a result of which in turn the risk of contamination can be reduced. For example, a flat sealing region can be characterizable in that an extent in one dimension is much smaller (for example smaller by at least one order of magnitude) than an extent in the two remaining dimensions.

A linear sealing region can be understood as meaning that only the region of the adjacent drive modules is sealed by a linear element, for example by the sealing element or a sealing element, in particular the sealing element already mentioned and claimed, on which the linear intermediate element or a linear intermediate region is formed between the adjacent drive modules and at which the risk of contamination by the ingress of particles and/or impurities from the outside is greatest. For example, a linear sealing region can be characterizable in that an extent in one dimension is much larger (for example larger by at least one order of magnitude) than an extent in the two remaining dimensions. A linear sealing region can be advantageously achieved by the application of/sealing with silicone.

In a further advantageous embodiment of the invention, it can be provided that the sealing region is circumferentially closed along a border of the sealing member.

It can be provided, for example, that the sealing region has a sealing element, in particular the sealing element already mentioned and claimed, and that the sealing region (for example, the sealing element) is circumferentially closed along each border of the sealing member. Particularly advantageously, the sealing can thus be undertaken directly following the sealing member. Furthermore, it can be provided that the sealing region comprises the entire drive module, except at the point where the drive module is covered by the sealing member. If the sealing region preferably has a sealing element, for example, the sealing element already mentioned, it can thus also be provided that the sealing element is initially formed at each border of the sealing member and, in addition, envelopes the entire drive module not covered by the sealing member, in order to further reduce a risk of contamination.

In a further advantageous embodiment of the invention, it can be provided that the sealing region contacts at least one boundary wall, for example, the boundary wall already mentioned, and/or a connection to a process station. Thus, a complete wall of a controlled environment can be designed as a drive surface and/or sealable access to the process station via the connection is made possible.

The boundary wall can be formed, for example, by the boundary wall already described. Particularly advantageously, stable sealing can thus be achieved not only between the adjacent drive modules, but also against the boundary wall.

In a further advantageous embodiment of the invention, it can be provided that the sealing region circumferentially encloses the arrangement of drive modules and seals against the or a boundary wall.

An arrangement of drive modules, as already introduced in the preamble of claim 1, can be understood as meaning, for example, the entirety of at least two drive modules. If the sealing region encloses the arrangement and thus one or more drive modules and also seals against the boundary wall, for example, the boundary wall already described, it can advantageously be achieved that all the further gaps in the drive module that do not directly face the interior of the controlled environment and which may nevertheless be contaminated can be sealed.

In a further advantageous embodiment of the invention, it can be provided that the sealing region contacts at least one sealing member.

It can be provided, for example, that the sealing region has a sealing element, for example, the sealing element already described and claimed, which in turn is in contact with at least one sealing member. Particularly advantageously, a seamless transition between sealing member and sealing region, or sealing element, can thereby be achieved.

It can be provided, for example, that the sealing member is connected to the sealing element in a force-fitting and/or form-fitting manner. Thus, particularly effective sealing can be achieved.

In a further advantageous embodiment of the invention, it can be provided that the sealing member is connected nonreleasably to the drive module.

The concept of “nonreleasably” can be understood as meaning, for example, that the sealing member cannot be removed from the drive module without being destroyed. Thus, unintentional or uncontrolled release of the sealing member can be prevented. Furthermore, it can be achieved that the sealing member, as soon as it is initially applied correctly to the drive module, does not slip or cause ripples.

However, it can also be advantageous if the sealing member is connected releasably to the drive module, since this allows interchangeability of the sealing member.

Alternatively or in addition, it can be provided that the sealing member is connected in an integrally bonded manner to the drive module.

It can be provided, for example, that the sealing member is formed, for example, from the film or a film, for example, the film already mentioned, which is connected to the drive module in an integrally bonded manner. This can be understood as meaning, for example, that the sealing member, for example the film, is adhesively bonded to the drive module. Other integrally bonded forms of connection are also possible.

In a further advantageous embodiment of the invention, it can be provided that the sealing member is flexible.

Flexible can be understood as meaning that the sealing member, for example, is advantageously adapted to a substrate, for example, the drive module, or is adaptable thereto, for example, is even stretchable. This can in turn be achieved by the film already described. By this means, for example, non-destructive release of the sealing member from the drive module can be achieved.

In a further advantageous embodiment of the invention, it can be provided that the sealing member is guided around an edge of the drive module or around all of the edges bordering the coupling side.

The edge of the drive module or all of the edges bordering the coupling side form a critical interface for particles and/or contaminants, in particular microbiological contaminants, which can enter the interior of the controlled environment via said regions. Thus, it is particularly advantageous that the sealing member is guided around at least one edge of the drive module or around all of the edges bordering the coupling side, since an additional sealing capability can thereby be realized. It can also be provided, for example, that two sealing members are guided around the edges of two drive modules and that said sealing members are in contact in the sealing region. Furthermore, it can be provided that two sealing members are guided around the edges of two drive modules and that these are connected in the sealing region to the sealing element or a sealing element, for example, the sealing element already described. This enables a high degree of sealing capability of the adjacent drive modules to be achieved.

In a further advantageous embodiment of the invention, it can be provided that the sealing member is rigid.

Rigid can mean, for example, that the sealing member is flexible to a certain extent and thus ductile, but also plastically deformable. It can also be provided, for example, that the material of the sealing member is rigid and is placed onto and/or applied to the drive module in such a manner that it can expand in a stress-free manner under thermal loading. However, it is advantageous if the sealing member is thermally stable over different temperature levels which may prevail during the process or a process in the controlled environment, and therefore a thermal expansion does not take place at all and the sealing member can thus be fixed on at least one drive module.

This can be achieved, for example, by a stainless steel layer, a plastics layer and/or a glass layer and/or a film and/or a composite material. Particularly advantageously, it can thereby be prevented that the sealing member slips and/or creases which results in turn in intermediate spaces that may be critical for contamination.

A thermal stability described can also apply to the sealing region.

In a further advantageous embodiment of the invention, it can be provided that the sealing member protrudes beyond the drive module, at least along one side.

It can be provided, for example, that the sealing member protrudes beyond the drive module and into the sealing region. This means that gaps between the drive modules can be bridged.

It can be provided, for example, that two sealing members protrude beyond the respective drive module and are in contact in the sealing region. The degree of a protrusion can be selected to differ here and, for example, can be a material thickness of the sealing region or a multiple thereof.

Furthermore, it can be provided, for example, that two sealing members protrude beyond the respective drive module where they form a transition to the sealing region. In this case, the sealing element or a sealing element can be formed in the sealing region, which advantageously contacts the sealing member or the sealing members for sealing the adjacent drive modules.

By this means, various possibilities for sealing the adjacent drive modules in the sealing region can be advantageously realized.

In a further advantageous embodiment of the invention, it can be provided that the two drive modules are not further away from each other than a distance allowing the transport unit, which is operated thereon, to be levitated and/or to be moved seamlessly.

Thus, particularly advantageously, the number of drive modules can be reduced and space saved, and the entire controlled environment can thus be designed more compactly.

It can be provided, for example, that it is precisely determined how far the two adjacent drive modules may be away from each other in order to allow a seamless levitation and/or movability of the transport unit at the transition from the two drive modules, and therefore it can advantageously be ensured that the transport unit can pass through both drive modules without any loss of levitation properties and/or properties relating to movability. The concept of “seamlessly” can be understood as meaning that the transport unit retains the levitation and/or movement properties when passing through the two adjacent drive modules.

In a further advantageous embodiment of the invention, it can be provided that at least one process station is arranged in the controlled environment.

It can be provided, for example, that sealing members and/or sealing regions lockable tightly together at least partially constitute or bring about a boundary between the controlled environment and an external environment.

Particularly advantageously, the transport unit can thus approach the process station and/or interact therewith, as a result of which, in turn, for example, pharmaceutical products can be processed and/or manufactured within the controlled environment.

Alternatively or additionally, it can be provided that at least one portion of the process station, in particular at least one filling needle, is arranged higher than at least one of the drive modules.

“Higher” can be understood as meaning, for example, that the portion of the process station, in particular the at least one filling needle, is arranged higher than an, in particular laminar, air flow of filtered air within the controlled environment. The air flow causes particles and/or impurities to be conducted in a predetermined direction in order to prevent contamination of the pharmaceutical product or a pharmaceutical product. Particularly advantageously, for example, the “first air” principle can thereby be realized since it can be ensured that the air after passing through a filter is not interrupted by other components, for example, the portion of the process station, in particular the filling needle, and/or contacts same, but rather contacts only an exposed product, for example, the exposed pharmaceutical product, and/or the surfaces that come into contact with said product. Thus, it can advantageously be prevented that particles and/or impurities of the higher portion of the process station, for example, the filling needle, are transferred through the air flow to the pharmaceutical product.

“Higher” can therefore be understood as meaning, for example, in relation to the air flow in the upstream direction and/or in relation to the Earth's field of gravity. For example, the portion may be located above one of the drive modules.

Alternatively or additionally, in order to achieve the stated object, the features of the further independent claim, which is directed to the use, are provided according to the invention. In particular, therefore, in order to achieve said object, the use of clamping means for the force-fitting and/or form-fitting connection of at least two drive modules of a controlled environment, preferably containments or isolators, in particular a controlled environment which has already been described and claimed, in particular wherein the sealing region or a sealing region is compressed, is proposed. The drive modules can therefore be easily brought to a defined position. It is thus also easily possible to compress the sealing region after the drive modules have been arranged, in order to achieve a tight seal.

The clamping means can serve particularly advantageously in this case to minimize a sealing region or the sealing region, for example, the sealing region already described and claimed. The sealing region is the region which necessarily should be sealed to minimize the risk of contamination of the interior of the controlled environment. The clamping means can be formed, for example, by the boundary wall or a boundary wall of the controlled environment, via which the drive modules can be fixed. For example, the clamping means can also be an adjustable frame, via which the at least two drive modules can be braced together in a force-fitting and/or form-fitting manner.

The clamping means can furthermore have the effect in particular that a sealing element or the sealing element, for example the sealing element already described, is compressed and thus pressed in the sealing region.

Alternatively or additionally, in order to achieve the stated object, one or more of the features disclosed hereon which are directed to the use, are provided according to the invention. In particular, therefore, in order to achieve said object, according to the invention the use of a sealing element in a sealing region for sealing adjacent drive modules of a controlled environment, for example the controlled environment already mentioned, against each other is proposed. Thus, it is described, in a structurally easy-to-handle variant, how a drive force can be introduced to transport units in the interior of the controlled environment without putting a closure of the controlled environment to the outside at risk.

The features and/or components described may be features and/or components already described.

Particularly advantageously, advantages already thereby described can be achieved.

Alternatively or additionally, in order to achieve the stated object, one or more of the features disclosed herein which are directed to the use, are provided according to the invention. In particular, in order to achieve the stated object, according to the invention the use of a transport unit for levitated traversing of a sealing member covering a drive module of a controlled environment, for example the controlled environment already mentioned, and/or of a sealing region optionally adjacent thereto, wherein drive modules of a transport device of the controlled environment that are adjacent in the sealing region seal against each other, is proposed. Thus, a virtually trouble-free or at least controlled transition of the transport units from one drive module to an adjacent drive module can be carried out, in particular despite the measures for sealing the controlled environment to the outside.

The features and/or components described may be features and/or components already described, as a result of which advantages already described can be realized.

### BRIEF DESCRIPTION OF THE DRAWINGS

The invention will now be described in more detail on the basis of exemplary embodiments, but is not restricted to the exemplary embodiments. Further exemplary embodiments emerge from combining the features of individual or multiple claims with one another and/or with individual or multiple features of the exemplary embodiment.

In each case in a highly simplified, schematic illustration

FIG. 1 shows a two-dimensional, schematic illustration (side view in section) of four drive modules with sealing members of a controlled environment, a boundary wall, a transport unit and a sealing region,

FIG. 2 shows a two-dimensional, schematic illustration of three adjacent drive modules of a controlled environment with sealing members covering said drive modules and with a sealing region adjacent to the sealing members and contacting the sealing members,

FIG. 3 shows a two-dimensional, schematic illustration of three adjacent, vertically arranged drive modules of a controlled environment with sealing members covering said drive modules and with a sealing region, wherein the sealing members are separated from one another,

FIG. 4 shows a two-dimensional, schematic illustration of three adjacent drive modules of a controlled environment with linear sealing members covering said drive modules and with a flat sealing region,

FIG. 5 shows a two-dimensional, schematic illustration of three adjacent drive modules of a controlled environment with sealing members covering said drive modules, wherein the sealing members protrude beyond the drive modules and are connected to the sealing region,

FIG. 6 shows a two-dimensional, schematic illustration of two adjacent drive modules of a controlled environment with sealing members covering said drive modules and with a sealing region, wherein each sealing member is guided around an edge of the respective drive module and is circumferentially closed with the sealing region,

FIG. 7 shows a two-dimensional, schematic illustration of two adjacent drive modules of a controlled environment with sealing members covering said drive modules, wherein each sealing member is guided around an edge of the respective drive module and are in contact in the sealing region,

FIG. 8 shows a two-dimensional, schematic illustration of a side view of two sealing members in contact in the sealing region, and

FIG. 9 shows a two-dimensional, schematic illustration of a top view of a controlled environment with eight drive modules, process stations and a levitatable transport unit which is movable on the drive modules.

### DETAILED DESCRIPTION

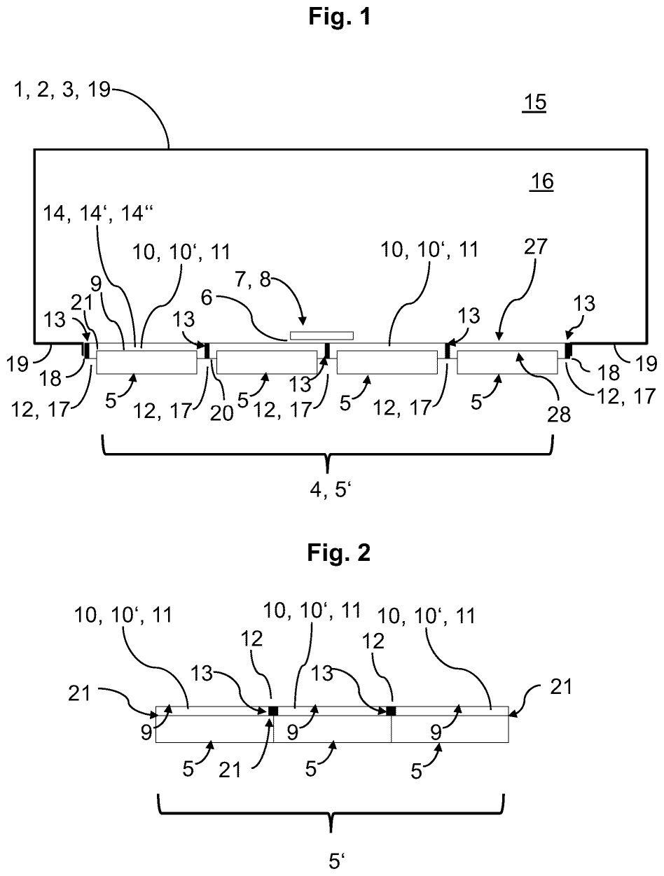

FIG. 1 shows a controlled environment, denoted as a whole by 1, here an isolator 2 or a containment 3, with a transport device 4, in a side view in cross section. The transport device 4 has four drive modules 5 in an arrangement 5′, wherein each drive module 5 is designed for magnetic levitation 6 of at least one transport unit 7 shown, here a mover 8.

The mover 8 is formed within the controlled environment 1 and is levitated from a coupling side 9 of the drive modules 5 and moved without contact. Furthermore, each drive module 5 is covered completely, but at least up to 60%, on the coupling side 9 with a sealing member 10, here a magnetically neutral separating layer 11, which is in the form of a flexible film 10′. A first side 27 of the sealing member 10 faces the controlled environment and a second side 28 of the sealing member 10 faces the coupling side. Respectively adjacent drive modules 5 are furthermore sealed against each other in a sealing region 12.

In the exemplary embodiment shown, each sealing region 12 has a sealing element 13; in total, five sealing regions 12 and five sealing elements 13 are formed. Each sealing region 12, here each sealing element 13, and each sealing member 10, here four sealing members 10, are formed from a material 14, here from or with an H₂O₂-resistant material 14′. In addition, the material 14 of the sealing region 12, here the material 14 of the sealing element 13, and the material 14 of the sealing member 10 consist of a non-outgassing material 14″, here a material 14′″ which does not outgas H₂O₂.

In FIG. 1 it can furthermore be seen that two sealing members 10 are connected to each other via each sealing region 12, here via each sealing element 13.

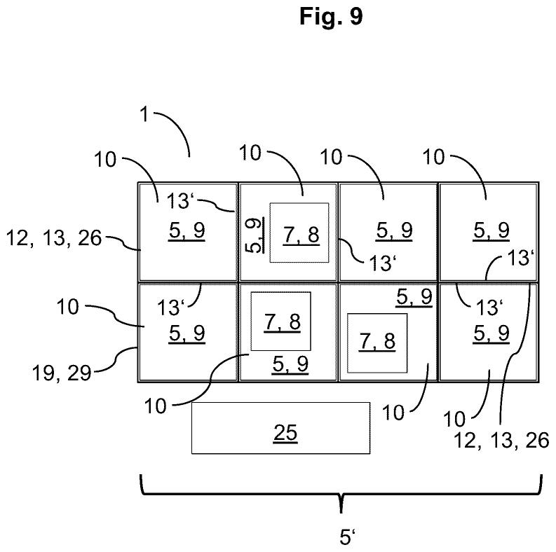

It is also possible that the sealing region 12 connects at least four or a multiplicity of sealing members 10 to one another in a mesh-like manner, as illustrated in more detail in FIG. 9.

It can furthermore be stated that the sealing region 12 contacts at least one sealing member 10.

Furthermore, it can be seen that each sealing region 12, here each sealing element 13, defines sealing 17 of the controlled environment 1 with respect to an external environment 15 of the controlled environment 1. Thus, it can be prevented that particles and/or impurities enter an inner environment 16 of the controlled environment from the external environment 15.

It can furthermore be stated that the sealing region 12 defines sealing 17 of the controlled environment 1 to the outside.

FIG. 1 furthermore illustrates that each outer drive module 5 of the arrangement 5′ forms a tight connection 18 to a boundary wall 19 of the controlled environment 1 and that each outer sealing region 12, here each outer sealing element 13, contacts the boundary wall 19 and thus seals the tight connection 18.

In the exemplary embodiment shown, each sealing member 10 is flat and each sealing region 12, here each sealing element 13, is linear, and therefore linear gaps 20 between the adjacent drive modules 5 can be sealed in a material-saving, cost-saving and efficient manner.

In the exemplary embodiment shown, the sealing members 10, here the films 10′, are connected to the respective drive module 5 in an integrally bonded manner. This is realized in that each sealing member 10 is adhesively bonded to the respective drive module 5. However, it may also be that individual sealing members 10 or a plurality of sealing members 10 are connected non-releasably or releasably to the respective drive module 5. It may furthermore also be that the sealing member 10 is designed here as a rigid component.

Each sealing member 10 of each drive module 5 is furthermore guided around the respective edge 21 of the drive module 5. This also results in the fact that the outer sealing members 10 are guided around all of the edges 21 bordering the coupling side 9.

The respectively adjacent drive modules 5 are furthermore, as shown, not further away from each other than a distance allowing the transport unit 7, which is operated thereon, to be levitated and/or to be moved seamlessly from one drive module 5 to the next drive module 5 in the controlled environment 1.

In contrast to the preceding exemplary embodiment, FIG. 2 shows only three drive modules 5 in an arrangement 5′.

Components and functional units which are functionally and/or structurally similar or identical to the preceding exemplary embodiment are denoted by the same reference signs and are not separately described once again.

Here too, each sealing region 12 has a sealing element 13.

In contrast to the preceding exemplary embodiment, three sealing members 10 are connected here to each other via two sealing elements 13, wherein also here each sealing member 10 covers the coupling side 9 of the respective drive modules 5. It can be stated that each sealing element 13 and thus each sealing region 12 contacts two drive modules 5 and two sealing members 10. Furthermore, each sealing region 12 can contact the boundary wall 19, not shown herein.

Furthermore, the sealing members 10 are not guided around an edge 21 of the drive modules 5, but end approximately with the edges 21.

Depending on how the respective sealing members 10 are connected to the respective sealing regions 12 with the sealing elements 13, for example, in an integrally bonded manner, it can also be stated that each sealing region with the sealing element 13 is formed integrally on the sealing member 10.

FIG. 3 shows, in contrast to the exemplary embodiment according to FIG. 2, a vertical arrangement of the drive modules 5 of the transport device 4, wherein adjacent sealing members 10 are not in contact. It can thus be stated that adjacent sealing members 10 are separated from each other.

Also in this exemplary embodiment, each sealing region 12 has a sealing element 13. The sealing region 12 with the sealing element 13 is formed in an intermediate region 22 between in each case two drive modules 5 where it seals the adjacent drive modules 5. Furthermore, in this exemplary embodiment, the sealing region 12 with the sealing element 13 encloses the individual drive modules 5 circumferentially and thus also seals against the boundary wall 19, not shown specifically herein. It can thus be stated that the sealing region 12 encloses the arrangement 5′ of drive modules 5 circumferentially and seals against the boundary wall 19. In the exemplary embodiment shown, the sealing elements 13 are located centrally in the intermediate space 22, but it is also conceivable that they are placed on the plane of the sealing members 10 and end therewith. The sealing elements 13 can thus also be offset from a center of the intermediate space 22.

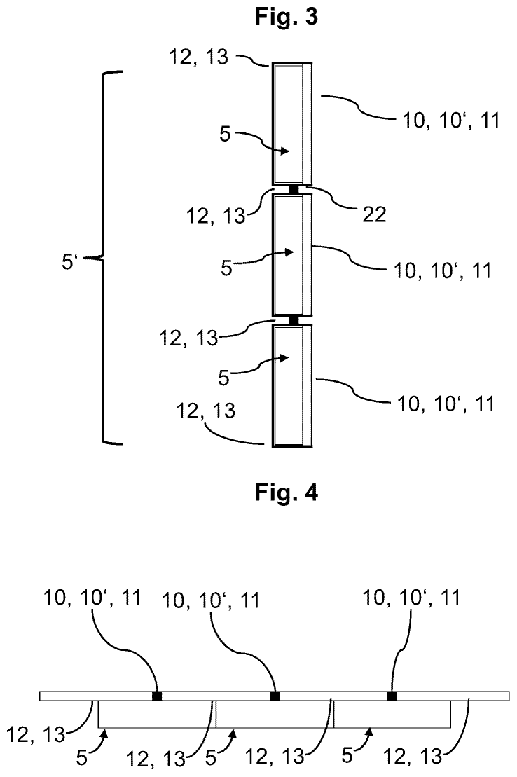

In contrast to the preceding exemplary embodiments, FIG. 4 shows that the sealing member 10 is no longer flat, but linear. Furthermore, the sealing region 12 with the sealing element 13 is not linear, but is flat.

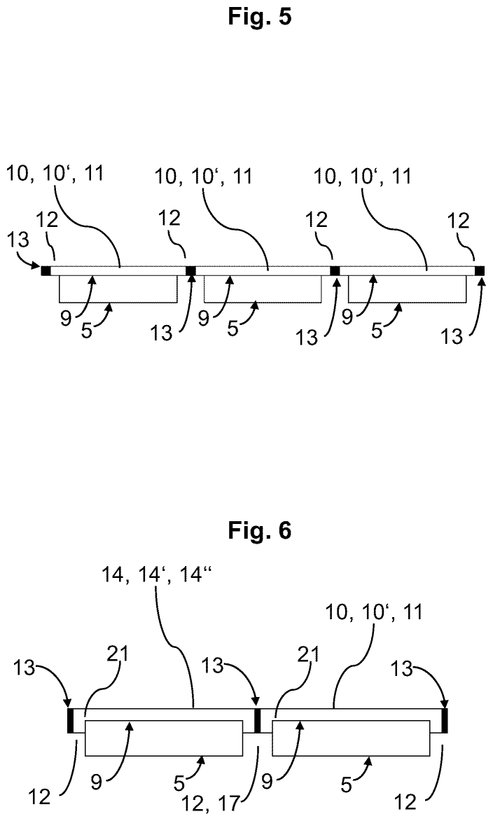

FIG. 5 shows in contrast, in particular with respect to FIG. 2, that each sealing member 10 protrudes along one side, here along each coupling side 9, above the respective drive module 5, specifically in such a way that each sealing member 10 contacts the sealing element 13 in the sealing region 12.

FIG. 6 shows two adjacent drive modules 5 according to FIG. 1. The sealing member 10 is flat, as also in FIG. 1, and runs around the edge 21 of each drive module 5.

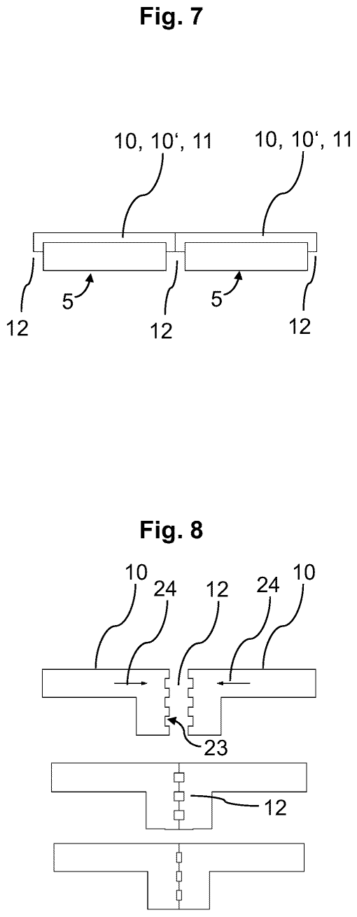

In contrast to the preceding exemplary embodiment, FIG. 7 shows two adjacent drive modules 5, wherein also here each drive module 5 is covered on the coupling side 9 with the sealing member 10. In contrast to the exemplary embodiment according to FIG. 6, the sealing region 12 has no additional sealing element 13 differentiating from the sealing member 10. On the contrary, the two sealing members 10 are connected to each other, for example welded or adhesively bonded and/or pressed together, in such a way that the sealing region 12 of the adjacent drive modules 5 is formed by the sealing member 10 itself. It can thus also be stated here that the sealing region 12 is formed integrally on the sealing member 10.

FIG. 8 shows a schematic illustration of two, here rigid, sealing members 10, which contact each other in the sealing region 12 and correspond to the exemplary embodiment according to FIG. 7, wherein the sealing members 10 have recesses 23 in the sealing region 12. By the use of clamping means (not illustrated specifically here) for the force-fitting and/or form-fitting connection of the at least two drive modules 5, not illustrated specifically here, by application of a clamping force 24 the two sealing members 10 are also pressed together in such a way that the sealing region 12 is compressed with the recesses 23. For example, the sealing element 13 can additionally also be inserted into the recesses 23.

FIG. 9 shows a top view of the controlled environment 1, in particular of the controlled environment according to the exemplary embodiment according to FIG. 1. Since this involves a top view of the controlled environment 1, in addition to the four drive modules 5 which have already been described for FIG. 1 and are arranged next to one another, four further drive modules 5 which are arranged behind the drive modules 5, which have already been described and are thus not visible in FIG. 1, are also visible here. In this exemplary embodiment, the controlled environment 1 thus comprises eight adjacent drive modules 5. The top view also shows the coupling side 9 of the drive modules 5. Furthermore, three movers 8 can be seen, which are levitated and moved on the coupling side 9 of the drive modules 5. The movers 8 approach at least one process station 25.

In the exemplary embodiment shown, it can also be readily seen that each sealing region 12 has a sealing element 13, here a mesh-like sealing element 13′. The sealing region 12 with the sealing element 13 is also closed circumferentially along a border 26 of each sealing member 10 covering the coupling side 9. It can also be stated that the sealing region 12 encloses the arrangement 5′ of drive modules 5 circumferentially and seals against the boundary wall 19. It can additionally be stated that the sealing region 12 connects a multiplicity of sealing members 10 to one another in a mesh-like manner. The sealing region 12 as a whole is thus formed in a mesh-like manner.

The invention therefore provides, in a controlled environment 1, sealing adjacent drive modules 5 of a transport device 4 of the controlled environment 1 in a sealing region 12 against each other such that particles and/or impurities, in particular microbiological impurities, do not enter the controlled environment 1 from the outside, wherein each drive module 5 is designed for levitation 6 of at least one transport unit 7, in particular mover 8, and a coupling side 9 of the drive module 5 is very substantially covered by a sealing member 10.

### LIST OF REFERENCE SIGNS

1 controlled environment
2 isolator
3 containment
4 transport device
5 drive module
5′ arrangement
6 levitation
7 transport unit
8 mover
9 coupling side
10 sealing member
10′ film
11 separating layer
12 sealing region
13 sealing element
13′ mesh-like sealing element
14 material
14′ H₂O₂-resistant material
14″ non-outgassing material
14′″ material not outgassing H₂O₂
15 external environment
16 internal environment
17 sealing
18 tight connection
19 boundary wall
20 gap
21 edge
22 intermediate region
23 recess
24 clamping force
25 process station
26 border
27 first side
28 second side
29 mesh

1. A controlled environment (1), comprising:
a transport device (4), which has at least two drive modules (5) in an arrangement (5′), each said drive module (5) being configured for magnetic levitation (6) of at least one transport unit (7);
a sealing member (10) which covers each said drive module (5) on a coupling side (9) thereof; and
a sealing region (12) that seals adjacent ones of the drive modules (5) against each other.

2. The controlled environment (1) as claimed in claim 1, wherein the sealing region (12) has at least one sealing element (13).

3. The controlled environment (1) as claimed in claim 1, wherein at least one of the sealing region (12) or the sealing member (10) is formed from or with an H₂O₂-resistant material (14′).

4. The controlled environment (1) as claimed in claim 1, wherein the sealing region (12) is formed integrally on the sealing member (10).

5. The controlled environment (1) as claimed in claim 1, wherein the sealing region (12) connects at least two of the sealing members (10) to one another.

6. The controlled environment (1) as claimed in claim 5, wherein adjacent sealing members (10) are separated from each other.

7. The controlled environment (1) as claimed in claim 1, wherein the sealing region (12) defines a sealing (17) of the controlled environment (1) to outside.

8. The controlled environment (1) as claimed in claim 1, wherein at least one drive module (5) of the arrangement (5′) forms a tight connection (18) to a boundary wall (19) of the controlled environment (1).

9. The controlled environment (1) as claimed in claim 1, wherein the sealing member (10) covers the coupling side (9) of the drive module (5) at least by up to 60%.

10. The controlled environment (1) as claimed in claim 1, wherein at least one of the sealing member (10) or the sealing region (12) is flat or linear, and the sealing region (12) is circumferentially closed along a border (26) of the sealing member (10).

11. The controlled environment (1) as claimed in any claim 1, wherein the sealing region (12) circumferentially encloses the arrangement (5′) of the drive modules (5) and seals against a boundary wall (19).

12. The controlled environment (1) as claimed in claim 1, wherein the sealing region (12) contacts at least one of the sealing members (10).

13. The controlled environment (1) as claimed in claim 1, wherein the sealing member (10) is connected at least one of nonreleasably or in an integrally bonded manner to the drive module (5).

14. The controlled environment (1) as claimed in claim 1, wherein the sealing member (10) is guided around an edge (21) of the drive module (5) or around all of the edges (21) bordering the coupling side (9).

15. The controlled environment (1) as claimed in claim 1, wherein two of the drive modules (5) are not further away from each other than a distance allowing the transport unit (7), which is operated thereon, to be at least one of levitated or moved seamlessly.

16. The controlled environment (1) as claimed in claim 1, further comprising at least one process station (25) arranged therein the controlled environment (1), and at least one portion of the process station (25) is arranged higher than at least one of the drive modules (5).

17. The controlled environment (1) as claimed in claim 1, further comprising clamping means for at least one of force-fitting or form-fitting connection of at least two adjacent ones of the drive modules (5) such that the sealing region (12) is compressed.

18. The controlled environment (1) as claimed in claim 1, wherein at least one sealing element (13) of the at least one sealing region (12) seals adjacent ones of the drive modules (5) against each other.

19. The controlled environment (1) as claimed in claim 1, wherein all of the drive modules (5) of the transport device (4) that are adjacent in the sealing region (12) seal against each other.
